(19) United States
(12) Patent Application Publication
(10) Pub. No.: US 2006/0178289 A1
(43) Pub. Date: Aug. 10, 2006

(54) Multifunctional material compositions and methods

(76) Inventor: Enrique Hernandez, Brownsville, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/330,638

(22) Filed: Jan. 12, 2006

Related U.S. Application Data
(63) Continuation-in-part of application No. 10/894,957, filed on Jul. 20, 2004.

(51) Int. Cl. C11D 3/02

(52) U.S. Cl. 510/511

(57) ABSTRACT

Multifunctional materials comprising an alkali metal silicate characterized by a degree of polymerization less than or equal to about 2.5. Cleaning product compositions comprising a multifunctional material, methods for making cleaning product compositions, and methods for cleaning comprising contacting a surface with a solution comprising a multifunctional material.

### PRIORITY CLAIM

This application is a continuation-in-part under 35 U.S.C. §120 of and claims priority to U.S. patent application Ser. No. 10/894,957, filed on Jul. 20, 2004, the full disclosure of which is incorporated herein by reference.

### TECHNICAL FIELD

The present disclosure, according to one embodiment, relates to multifunctional materials comprising alkali metal silicates having a low degree of polymerization. This disclosure also relates to cleaning product compositions comprising a multifunctional material of the present disclosure.

### BACKGROUND

Cleaning products may be grouped into four general categories: personal cleansing, laundry, dishwashing, and household cleaning. Within each category are different product types formulated with ingredients selected to perform a broad cleaning function as well as to deliver properties specific to that product. Cleaning products generally include a surfactant and a builder.

Surfactants are organic chemicals that change the properties of water. By lowering the surface tension of water, surfactants enable the cleaning solution to wet a surface (e.g., clothes, dishes, countertops) more quickly, so soil can be readily loosened and removed (usually with the aid of mechanical action). Surfactants also emulsify oily soils and keep them dispersed and suspended so they do not settle back on the surface.

There are different types of builders and, sometimes more than one type of molecule is involved to form a “builder system.” Builders function in several ways. They increase the alkalinity of the wash solution, which helps the surfactant activity and also helps to emulsify fats and oils in the soiled fabrics. They also help to “break” clay-types of dirt from fabrics, and combine with them to help prevent redeposition on fabrics. They also function to combine with hard water mineral ions, thus “softening” the water.

Softening water may prevent water hardness ions from reacting with other detergent ingredients, which could cause them to work less efficiently or precipitate from solution. Water hardness ions can form insoluble salts, which may become encrusted in fabrics and deposited on solid surfaces inside a washing machine. In this way, builders extend the life of the washing machine. Additionally, soil molecules are often bound to fabric surfaces by calcium ion bridging; removal of calcium ions therefore may help stain removal.

The primary function of builders is to reduce water hardness (e.g., Ca²⁺ and Mg²⁺). This can be done either by sequestration or chelation, by precipitation, or by ion exchange. Thus, builders are often divided into three general categories: (1) sequestrating/chelating builders, which are soluble builders and form soluble complexes with cations; (2) ion exchange builders, which are insoluble builders and form insoluble complexes with cations; and (3) precipitating builders, which are soluble builders and form insoluble complexes with cations. Complex phosphates and sodium citrate are common sequestering builders. Sodium carbonate and sodium silicate are precipitating builders. Sodium aluminosilicate (zeolite) is an ion exchange builder.

Sequestrating builders disperse and suspend dirt. In aqueous solutions, these compounds combine with metal ions, like calcium, to substantially inactivate the ion. Some sequestrating builders, like sodium tripolyphosphate (STPP), form complexes with mineral ions, which stay in solution and may be rinsed away. Over time and with exposure to water, STPP will decompose into a mono-phosphate, or “orthophosphate,” called trisodiumphosphate (“TSP”). TSP is often used for cleaning hard surfaces where a precipitate is not a problem, but due to its precipitate formation is not favored for laundry use, as the precipitate often forms a white film on fabrics. Moreover, the use of phosphate builders is limited or banned in many U.S. states, as well as in much of Europe because of eutrophication. In Europe, and increasingly in the USA, compounds such as zeolites (aluminum silicates) and phosphonates (a form of phosphate not thought to promote eutrophication) are being used as substitutes for complex phosphates in laundry detergents.

Ion exchange builders include zeolites. Zeolites are synthetic sodium aluminum silicates that are used in detergents (among other applications) for their cation-exchanging capacity. Most modern laundry detergent powders and tablets that do not contain phosphates, contain zeolites. Zeolites replace the water hardness ions (e.g., Ca²⁺ and Mg²⁺) with Na⁺ ions. Zeolites, like clays, are insoluble in water and are present in the wash as finely dispersed crystals (with a diameter of ˜4 microns). Zeolite builders are expensive, non-soluble in aqueous liquids, and suffer from poor performance.

Common precipitating builders include sodium carbonate (soda ash or Na₂CO₃) and silicates. Precipitating builders generally have high alkalinity and are good for “breaking” soil from fabric, but often forms an insoluble compound with hard water mineral ions, and also with mineral ions in the soil they release from fabrics. The insoluble compounds that are formed may redeposit on fabrics and washer parts. On fabrics it can look like white lint or powder. On washer parts, it can form a rock-like scale which can be harmful to the washer mechanisms.

### SUMMARY

The present disclosure, according to one specific example embodiment, provides a multifunctional material comprising an alkali metal silicate characterized by a degree of polymerization less than or equal to about 2.5.

The present disclosure, according to another specific example embodiment, provides a cleaning product composition comprising a multifunctional material, the multifunctional material comprising an alkali metal silicate characterized by a degree of polymerization less than or equal to about 2.5.

The present disclosure, according to another specific example embodiment, provides a method for making a cleaning product composition comprising: providing a multifunctional material and a surfactant, the multifunctional material comprising an alkali metal silicate characterized by a degree of polymerization less than or equal to about 2.5; and combining the multifunctional material and the surfactant to form the cleaning product composition.

The present disclosure, according to another specific example embodiment, provides a method for cleaning comprising contacting a surface with a solution comprising a multifunctional material, the multifunctional material comprising an alkali metal silicate characterized by a degree of polymerization less than or equal to about 2.5.

### DESCRIPTION

The present disclosure, according to one embodiment, provides multifunctional materials including an alkali metal silicate. The alkali metal silicate may have a particular degree of polymerization.

Multifunctional material of various embodiments of the disclosure may be useful in any application that may utilize one or more of the following: a builder, a conditioner, an alkaline agent, a filler, a carrier, an antiredeposition agent, a corrosion inhibitor, processing aid (i.e., provides physical characteristics, such as proper pour or flow, viscosity, solubility, stability, and density), and a neutralizing agent.

Multifunctional materials may be included in a cleaning product composition, and when included in such a composition, smaller amounts of active ingredients (or none at all, in some cases) may be used in the cleaning product composition while achieving the same or better cleaning performance. The multifunctional materials of the present disclosure may be capable of softening water and tend not to deposit on the fibers of the cloth being washed. Multifunctional materials also have improved builder properties and perform better than or equivalent to phosphate builders. When used in a cleaning product composition, multifunctional materials may be capable of inhibiting the redeposition of soils, as well as inhibiting the corrosion of metals by, for example, synthetic detergents and complex phosphates. Multifunctional materials also may supply and maintain alkalinity, which assists cleaning, help keep removed soil from redepositing during washing, and emulsify oily and greasy soils.

According to one embodiment, of the present disclosure provides a multifunctional material comprising an alkali metal silicate characterized by a degree of polymerization less than or equal to about 2.5. When placed in a liquid, for example water, the multifunctional material may form a multifunctional material solution. In solution, the multifunctional material may comprise silicate anions of various distributions. The anionic species distribution (i.e., silicate speciation) may affect the properties of the silicate.

The silicate ions present in a solution formed with a multifunctional material may exist as an equilibrium of monomeric and polymeric species. The concentrations of monomer and polymer in the equilibrium depend in part on the silica content and the SiO₂:Na₂O ratio of the solution. The monomeric species include silicon oxides that are not bonded to any other silicon atoms (e.g., SiO₄⁴⁻). Structurally, a monomeric silicon oxide may be represented as a tetrahedral anion with a silicon atom at the center of an oxygen-cornered, four sided pyramid. Other atoms may be associated with these oxygen atoms, such as hydrogen, sodium, or potassium. The oxygen atom of the silicon oxide monomer may be linked to other silicon atoms through tetrahedral coordination. In this way other, “polymerized” forms of silicon oxide anions may be formed. In polymeric forms of silicon oxides, the silicon atom of a monomer may be linked to between one and four other silicon atoms through a shared oxygen, which ultimately may form two- and three-dimensional structures.

A shorthand for representing the monomeric and polymeric species in a silicate solution uses the ratio of silicon dioxide to a alkali-metal oxide as follows: xSiO₂:M₂O, in which “M” is an alkali metal (e.g., sodium (Na) or potassium (K)) and “x” represents the weight ratio of silica to alkali-metal oxide. The electrical charges of the anions may be balanced by the sodium or potassium cations. Monomeric species form at SiO₂:Na₂O ratios of from about 0.5 to about 1.5. Polymeric species form at SiO₂:Na₂O ratios of from above about 1.5. To illustrate, a concentrated silicate solution having a SiO₂:Na₂O ratio of 1.0 or 0.5 mainly consists of SiO₃⁻² and HSiO⁻; whereas solutions with higher SiO₂:Na₂O ratio are characterized by increasing polymer concentration and increasing polymer size (up to 30 nm diameter). See R. K. Iler, The Chemistry of Silica, John Wiley and Sons, New York (1979). At ratios greater than about 2.0, polymer species begin to form as solids in the solution. Table 1 shows how the SiO₂:Na₂O ratio affects the degree of polymerization of an sodium silicate solution. See Nauman & Debye, J. Phys. Chem. 55:1 (1951).

TABLE 1

| SiO₂:Na₂O | Degree of | Molecular |
|---|---|---|
| Ratio | polymerization | weight |
| 0.48 | — | 60 |
| 1.01 | — | 70 |
| 2.0 | 2.5 | 150 |
| 2.2 | 3 | 180 |
| 2.6 | 7 | 420 |
| 3.1 | 15 | 900 |
| 4.0 | 27 | 1600 |

As mentioned above, the concentrations of monomer and polymer also depend in part on the silica content of the solution. Thus, for example, adding a silica source (e.g., colloidal silicate) to a high-ratio silicate solution may increase the SiO₂:Na₂O ratio, thereby forming more polymeric species. Monomeric species are better able to sequester cations (e.g., calcium cations) than polymeric species. The presence of the monomeric species may be measured using molybdic acid reagent as described in G. B. Alexander, “The Reaction of Low Molecular Weight Silicic Acids with Molybdic Acid” J. Am. Chem. Soc. 75:5655-7 (1953).

Accordingly, as discussed above, the distribution of monomer and polymer species in a multifunctional material solution also may vary based on changes in the solution's chemical environment. In solution, polymeric silicate species are known to form porous film deposits that appear white and opaque when dried, which is generally not a desirable form of deposition on fabrics or metals. In contrast, multifunctional materials, in which monomeric silicate species may predominate, may form non-porous and clear deposits.

The multifunctional materials of the present disclosure may be made using methods known in the art. For example, a multifunctional builder may be made by mixing together two or more natural or partially treated (ground or comminuted) primary raw materials or minerals, in proportions according to the desired SiO₂:Na₂O ratio, raising the mixture to a reacting temperature, such as by introducing the mixture into a furnace, reacting the mixture at the reacting temperature, and forming the multifunctional builder. One or more of the materials can be in the molten state upon mixing of the other ingredients. The process system for making the material can be batch or continuous. The primary raw materials or minerals contain a source of source of silicon oxide, and a source of disodium oxide. Examples of sources of silicon oxide are silica sand, as well as quartzite and cristobalite. A disodium oxide may be needed to form the various silicate species, and can be obtained from, for example, trona, sodium carbonate, and sodium hydroxide. The raw materials are balanced to provide a multifunctional material having a desired or preferred SiO₂:Na₂O ratio or degree of polymerization. Other inorganic raw materials useful in laundry and cleaning products may optionally be included in the mixture, such as, for example, phosphorous oxide.

As mentioned above, the multifunctional materials of the present disclosure may be included in a cleaning product composition. Accordingly, the present disclosure provides, according to another specific example embodiment, cleaning product compositions comprising a multifunctional material and a surfactant. Such cleaning product compositions may be used as, for example, a personal cleaning product, a laundry detergent, a laundry aid, a dishwashing product, and a household cleaner.

Under the appropriate conditions, the multifunctional materials may perform several functions in a cleaning product composition including, but not limited to, water hardness removal, corrosion inhibition, provide alkalinity, carrier, processing aid (i.e., provides physical characteristics, such as proper pour or flow, viscosity, solubility, stability, and density), and antiredeposition. And when included in a cleaning product composition, the multifunctional material may, among other things, improve the performance of the cleaning product composition. The multifunctional material may be present in the cleaning product composition in a range of between about 3% to about 60% by weight of the cleaning product composition.

Any suitable surfactant may be used in the cleaning product compositions of the present disclosure. Suitable surfactants include, but are not limited to, anionic surfactants (e.g., linear alkylbenzene sulfonate (LAS), alcohol ethoxysulfates, alkyl sulfates, and soap), nonionic surfactants (e.g., alcohol ethoxylates), cationic surfactants (e.g., quaternary ammonium compounds), and amphoteric surfactants (e.g., imidazolines and betaines). The specific surfactant chosen may depend on the application or particular properties desired. For example, anionic surfactants may be chosen when the cleaning product is a laundry or hand dishwashing detergent, household cleaner, or personal cleansing product; nonionic surfactants may be chosen when the cleaning product is a laundry or automatic dishwasher detergent or rinse aid; cationic surfactants may be chosen when the cleaning product is a fabric softener or a fabric-softening laundry detergent; and amphoteric surfactants may be chosen for use when the cleaning product is a personal cleansing product or a household cleaning product.

The cleaning product compositions also may further comprise other optional components depending on, among other things, a desired application for a cleaning product composition and the desired properties of a cleaning product composition. For example, optional components may be added to provide a variety of functions, such as increasing cleaning performance for specific soils/surfaces, and ensuring product stability. The cleaning product compositions may be in any form, such as, for example, a dry detergent (e.g., a powder) or a liquid detergent (e.g., a gel or a spray). Similarly, the cleaning product compositions may be concentrated, either in a liquid or dry form.

A number of optional components may be included in the cleaning product compositions of the present disclosure. Examples of suitable optional components include, but are not limited to, disinfectants, bleaches, abrasives (e.g. calcite, feldspar, quartz, sand), bluings (i.e., a blue dye or pigment), enzymes (e.g., amylase, lipase, protease, cellulase), fabric softeners, hydrotropes (e.g., cumene sulfonates and ethyl alcohol to inhibit liquid products from separating into layers and/or to ensure product homogeneity), preservatives (e.g., butylated hydroxytoluene, thylene diamine tetraacetic acid, glutaraldehyde), fragrances, processing aids (e.g., clays, polymers, solvents, sodium sulfate), solvents (ethanol, isopropanol, propylene glycol), suds control agents (e.g., alkanolamides, alkylamine oxides, silicones), STPP, zeolites, foam inhibitors, optical brighteners, acids (e.g., acetic acid, citric acid, hydrochloric acid), and alkalis (e.g., ammonium hydroxide, ethanolamines, sodium carbonate, sodium hydroxide).

One specific example embodiment of a cleaning product composition may comprise LAS, a multifunctional material of the present disclosure, and sodium sulphate. In one aspect, the cleaning product may be formulated using 18 g of LAS, 41 g of a multifunctional material of the present disclosure having a SiO₂:Na₂O ratio of 1, and 41 g of sodium sulfate. In another aspect, the cleaning product may be formulated using 15 g of LAS, 31 g of a multifunctional material of the present disclosure having a SiO₂:Na₂O ratio of 1, and 54 g of sodium sulfate.

The cleaning product compositions may be formulated using methods known in the art. For example, solid, dry cleaning product compositions may be formulated using agglomerater techniques or with spray-drying techniques (e.g., using a tower) or both. Such products may be in the form of a hollow particle or a solid particle. The cleaning product compositions also may be formulated as liquid using methods known in the art. Likewise, the cleaning product compositions may in a concentrated or compacted form.

The present disclosure, according to another specific example embodiment, also provides methods of forming cleaning product compositions. Such methods generally comprise providing a surfactant and a multifunctional material and combining the surfactant and multifunctional material. In one aspect, cleaning product compositions may be formed by providing a surfactant and a polymerized silicate and combining the surfactant and polymerized silicate under conditions sufficient to at least partially depolymerize the polymerized silicate, thereby allowing the formation of a multifunctional material.

To facilitate a better understanding of the present invention, the following examples of specific example embodiments are given. In no way should the following examples be read to limit or define the entire scope of the invention.

### EXAMPLE 1

The calcium binding capacity of STPP was measured and compared to the calcium binding capacity of a multifunctional material example comprising sodium silicate having a SiO₂:Na₂O ratio of 1. The comparison is shown in Table 2.

The calcium binding capacity was determined by reacting a pre mixed sample solution with an excess of Ca²⁺ and titrating the excess Ca²⁺ with standard EDTA to determine the uptake of Ca²⁺. Results are calculated as milligrams of CaCO₃ per gram of the test sample, and calculated as follows:

$$Binding Capacity = \frac{( B - T ) \times f \times 100}{( S W ) \times ( solids )}$$

in which, B is the milliliters of EDTA for the blank titration, T is the milliliters of EDTA for the sample titration; F is the milligrams of CaCO₃ per milliliter of EDTA solution as determined in the standardization of EDTA procedure, SW is the sample weight in grams, and solids is the percent alumino silicate solids (100.00−(% H₂O+% Na₂CO₃)).

Briefly, 20 mL of distilled water was put into a 150 mL beaker. The sample was transferred into the beaker and stirred for 15 minutes. Then 20.0 mL of a stock Ca²⁺ solution was pipetted into the beaker and stirred for 15 minutes. The sample was uniformly dispersed with no large chunks. The mixture was then filtered through a 0.45 μm and into a clean 500 mL filtering flask for titration. Next, 15 mL of pH 10.0 Buffer, 5 mL of magnesium complex of EDTA, and 3-5 drops of EBT (Eriochrome Black T) indicator were added to the filtrate in the filtering flask (Buffer, magnesium complex EDTA, and EBT indicator were prepared as described below). A stirring bar was added to the filtering flask and the sample solution was titrated with EDTA solution to a blue endpoint (i.e., until all red color disappears and the solution is distinctly blue). 10-15 mL of the buffer solution was then added to the filtering flask. If a change occurred, the titration was continued. If no change occurred the titration was recorded. A blank titration was also prepared by titrating 10 mL of the Ca⁺² stock solution to which has been added 50 mL of distilled water, 15 mL of pH 10 Buffer, 5 mL of magnesium complex of EDTA solution, and 3-5 drops of EBT indicator.

The Buffer was prepared in two liter batches by weighing 35 g of NH₄Cl into a one liter volumetric flask, adding 500 mL distilled water, then adding 285 mL of concentrated NH₄OH, and diluting to volume with distilled water. The magnesium complex of EDTA was prepared by weighing into a 600 mL beaker 37.20 g of Na₂EDTA·2H₂O, adding 500 mL distilled water to completely dissolve the Na₂EDTA·2H₂O, then weighing 24.65 g of MgSO₄·7H₂O to the 600 mL beaker, adding a few drops of phenolphthalein indicator, then while stirring adding enough 50% NaOH solution to turn the solution just pink, dissolving the precipitate that forms when the phenolphthalein endpoint is reached with about 20 mL of 50% NaOH, and transferring the solution to a liter volumetric flask and dilute to volume with distilled water. When properly prepared, 5 mL of the solution should assume a dull violet color when treated with 10 mL of the pH 10.0 Buffer and a few drops of EBT indicator. The addition of a single drop of Na₂EDTA solution should turn the solution blue. If this condition is not met, additions of small amounts of MgSO₄·7H₂O or EDTA should be made to the liter volumetric flask until this test is satisfied. The EBT indicator was prepared by weighing 0.2000+0.01 g of the solid indicator into a 25 mL indicator bottle, adding 15 mL of triethanolamine and 5 mL of ethyl alcohol, and then the solution was swirled until the indicator was completely dissolved into a blue/black solution. The Na₂EDTA solution was prepared by weighing 78.00 g of Na₂EDTA·2H₂O into a liter volumetric flask, adding about 500 mL of hot distilled water while swirling until the Na₂EDTA·2H₂O was completely dissolved, and diluting to volume with distilled water.

As shown in Table 2, the multifunctional material example was about 20% better than STPP at binding calcium.

TABLE 2

| | | Multifunctional |
|---|---|---|
| | STPP | Material Example |
| Calcium Binding Capacity | 644.94 | 778.86 |
| (mg CaCO₃/g) | | |

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A multifunctional material comprising an alkali metal silicate characterized by a degree of polymerization less than or equal to about 2.5.

2. The multifunctional material of claim 1, wherein the alkali metal silicate has a SiO₂:Na₂O ratio of from about 1 to about 2.

3. The multifunctional material of claim 1, wherein at least a portion of the alkali metal silicate is monomeric.

4. The multifunctional material of claim 1, wherein at least a portion of the alkali metal silicate is monomeric when dissolved in a liquid.

5. The multifunctional material of claim 1, further comprising water such that the multifunctional material is at least partially in solution.

6. The multifunctional material of claim 1, wherein the alkali metal silicate is sodium silicate.

7. The multifunctional material of claim 1, wherein the alkali metal silicate is potassium silicate.

8. A cleaning product composition comprising a multifunctional material, the multifunctional material comprising an alkali metal silicate characterized by a degree of polymerization less than or equal to about 2.5.

9. The cleaning product composition of claim 8, wherein the alkali metal silicate has a SiO₂:Na₂O ratio of from about 1 to about 2.

10. The cleaning product composition of claim 8, wherein the alkali metal silicate is sodium silicate or potassium silicate.

11. The cleaning product composition of claim 8, wherein the cleaning product is a dry detergent.

12. The cleaning product composition of claim 8, wherein the cleaning product is a liquid detergent.

13. The cleaning product composition of claim 8, wherein the cleaning product is concentrated.

14. The cleaning product composition of claim 8, wherein multifunctional material is used in an amount of from about 3% to about 60%, by weight of the cleaning product composition.

15. The cleaning product composition of claim 8, further comprising a surfactant.

16. The cleaning product composition of claim 8, further comprising a surfactant, the surfactant comprising a linear alkyl benzene sulfonate.

17. The cleaning product composition of claim 8, further comprising a surfactant, the surfactant chosen from at least one of an anionic surfactant, a nonionic surfactant, a cationic surfactant, and an amphoteric surfactant.

18. The cleaning product composition of claim 8, further comprising a surfactant, wherein the surfactant is used in an amount in the range of from about 1% to about 50% by weight of the detergent.

19. The cleaning product composition of claim 8, further comprising an optional component.

20. The cleaning product composition of claim 8, further comprising an optional component, the optional component selected from the group consisting of a disinfectant, a bleach, an abrasive, a bluing agent, an enzyme, a fabric softener, a hydrotrope, a preservative, a fragrance, a processing aid, a solvent, a suds control agent, STPP, a zeolite, a foam inhibitor, an optical brightener, an acid, a base, ammonium hydroxide, ethanolamines, sodium carbonate, sodium hydroxide, and combinations thereof.

21. A method for making a cleaning product composition comprising:
providing a multifunctional material and a surfactant, the multifunctional material comprising an alkali metal silicate characterized by a degree of polymerization less than or equal to about 2.5; and
combining the multifunctional material and the surfactant to form the cleaning product composition.

22. The method of claim 21, wherein the alkali metal silicate has a SiO₂:Na₂O ratio of from about 1 to about 2.

23. The method of claim 21, wherein the alkali metal silicate is sodium silicate or potassium silicate.

24. The method of claim 21, further comprising combining with the multifunctional material and the surfactant with an optional component.

25. The method of claim 21, further comprising combining with the multifunctional material and the surfactant with an optional component, the optional component selected from the group consisting of a disinfectant, a bleach, an abrasive, a bluing agent, an enzyme, a fabric softener, a hydrotrope, a preservative, a fragrance, a processing aid, a solvent, a suds control agent, STPP, a zeolite, a foam inhibitor, an optical brightener, an acid, a base, ammonium hydroxide, ethanolamines, sodium carbonate, sodium hydroxide, and combinations thereof.
